(19) United States
(12) Patent Application Publication
(10) Pub. No.: US 2020/0258520 A1
(43) Pub. Date: Aug. 13, 2020

(54) SPEECH RECOGNITION FUNCTION-EQUIPPED ELECTRONIC DEVICE AND OPERATION-RELATED NOTIFICATION METHOD THEREOF

(71) Applicant: Samsung Electronics Co., Ltd., Suwon-si (KR)

(72) Inventors: Donghee SUH, Suwon-si (KR); Hojun JAYGARL, Suwon-si (KR); Jinwoong KIM, Suwon-si (KR); Kwangbin LEE, Suwon-si (KR); Minsung KIM, Suwon-si (KR); Youngbin KIM, Suwon-si (KR)

(21) Appl. No.: 16/790,441

(22) Filed: Feb. 13, 2020

(30) Foreign Application Priority Data
Feb. 13, 2019 (KR) 10-2019-0016907

(51) Int. Cl. G10L 15/22; G06F 3/16

(52) U.S. Cl. CPC G10L 15/22; G10L 2015/225; G10L 2015/223; G06F 3/167

(57) ABSTRACT

An electronic device includes a communication circuit, a display, a microphone, a processor, and a memory storing instructions that, when executed by the processor, cause the processor to display a first user interface on the display, receive a user's utterance for executing a task through the microphone, control the communication circuit to transmit data related to the received user's utterance to an external server, control the communication circuit to receive notification information associated with execution of the task and a plan for executing the task from the external server, display a second user interface including notification information received from the external server in association with execution of the task on the display, and display a third user interface for the task executed based on the plan received from the external server on the display based on satisfaction of a condition for executing the task.

### CROSS-REFERENCE TO RELATED APPLICATION

This application is based on and claims priority under 35 U.S.C. 119 to Korean Patent Application No. 10-2019-0016907 filed on Feb. 13, 2019 in the Korean Intellectual Property Office, the disclosure of which is herein incorporated by reference in its entirety.

### BACKGROUND

### 1. Field

The disclosed various embodiments relate to a speech recognition function-equipped electronic device and an operation-related notification method thereof

### 2. Description of Related Art

With the advance of speech recognition technologies, speech recognition is becoming a popular feature of electronic devices equipped with a speech input device (e.g., microphone). For example, a speech recognition-enabled electronic device may recognize speech data from a user's utterance, detect an intent of the user's utterance, and execute an operation corresponding to the intent.

### SUMMARY

However, it may happen that the electronic device misrecognizes the user's utterance and, in this case, the electronic device is likely to execute an operation not corresponding to the intent of the user's utterance.

According to various embodiments of the disclosure, the electronic device is capable of recognizing speech data of a user's utterance and providing the user with information on the operation according to intent of the user's utterance to be executed before execution of the operation corresponding to the intent of the user's utterance.

According to various embodiments of the disclosure, the electronic device is capable of providing the user with information on an execution result of the operation corresponding to the intent of the detected user's utterance.

According to various embodiments, an electronic device is provided. The electronic device includes a communication circuit, a display, a microphone, a processor operationally connected to the communication circuit, the display, and the microphone, and a memory operationally connected to the processor and configured to store instructions, executable by the processor, for displaying a first user interface on the display, receiving a user's utterance for executing a task through the microphone, transmitting data related to the received user's utterance to an external server via the communication circuit, receiving notification information associated with execution of the task and a plan for executing the task from the external server via the communication circuit, displaying a second user interface including notification information in association with execution of the task received from the external server on the display, and displaying a third user interface for the task executed based on the plan received from the external server on the display based on satisfaction of a condition for executing the task.

According to various embodiments, an electronic device is provided. The electronic device includes a communication circuit, a display, a microphone, a processor operationally connected to the communication circuit, the display, and the microphone, and a memory operationally connected to the processor and configured to store instructions, executable by the processor, for displaying a first user interface on the display, receiving a user's utterance for executing a task through the microphone, transmitting data related to the received user's utterance to an external server via the communication circuit, receiving a plan for executing the task and notification information associated with execution of the task from the external server via the communication circuit, and displaying a second user interface for the task executed based on the plan received from the external server and the notification information associated with the execution of the task on the display.

According to various embodiments, an electronic device is provided. The electronic device includes a communication circuit, a display, a microphone, a processor operationally connected to the communication circuit, the display, and the microphone, and a memory operationally connected to the processor and configured to store instructions, executable by the processor, for displaying a first user interface on the display, receiving a user's utterance for executing a task through the microphone, transmitting data related to the received user's utterance to an external server via the communication circuit, receiving a plan for executing the task from the external server via the communication circuit, and displaying a second interface for the task executed based on the plan received from the external server and notification information on an execution result of the task on the display.

According to various embodiments, a method for providing a notification related to an operation of a speech recognition function-equipped electronic device is provided. The method includes displaying a first user interface on a display, receiving a user's utterance for executing a task through a microphone, transmitting data related to the received user's utterance to an external server via a communication circuit, receiving notification information associated with execution of the task and a plan for executing the task from the external server via the communication circuit, displaying a second user interface including the notification information received from the external server in association with the execution of the task on the display, and displaying a third user interface for the task executed on the display based on the plan received from the external server based on satisfaction of a condition for executing the task.

According to various embodiments, a method for providing a notification related to an operation of a speech recognition function-equipped electronic device is provided. The method includes displaying a first user interface on a display, receiving a user's utterance for executing a task via a microphone, transmitting data related to the received user's utterance to an external server via a communication circuit, receiving a plan for executing the task and notification information associated with execution of the task from the external server via the communication circuit, and displaying a second user interface for the task executed based on the plan received from the external server and the notification information associated with the executed task on the display.

According to various embodiments, a method for providing a notification related to an operation of a speech recognition function-equipped electronic device is provided. The method includes displaying a first user interface on a display, receiving a user's utterance for executing a task via a microphone, transmitting data related to the received user's utterance to an external server via a communication circuit, receiving a plan for executing the task from the external server via the communication circuit, and displaying a second user interface for the task executed based on the plan received from the external server and notification information on an execution result of the task.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document. Those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device in a network environment according to various embodiments;

FIG. 2A is a block diagram illustrating a configuration of an integrated intelligence system according to various embodiments;

FIG. 2B is a diagram illustrating a configuration of a database storing information on a relationship between concepts and operations according to various embodiments;

FIG. 3 is a diagram illustrating screen displays for explaining a procedure for a user terminal to process a speech input via an intelligence application according to various embodiments;

FIG. 4 is a block diagram illustrating signal flows among a concept action network, a service control module, and an application according to various embodiments;

FIG. 5 is a flowchart illustrating an operation-related notification procedure of a speech recognition function-equipped electronic device according to an embodiment;

FIGS. 6A and 6B are a diagram illustrating screen displays for explaining an operation-related notification method of a speech recognition function-equipped electronic device according to an embodiment;

FIG. 7 is a flowchart illustrating an operation-related notification procedure of a speech recognition function-equipped electronic device according to an embodiment;

FIG. 8 is a diagram illustrating screen displays for explaining an operation-related notification method of a speech recognition function-equipped electronic device according to an embodiment;

FIG. 9 is a flowchart illustrating an operation-related notification procedure of a speech recognition function-equipped electronic device according to an embodiment; and

FIG. 10 is a diagram illustrating screen displays for explaining an operation-related notification method of a speech recognition function-equipped electronic device according to an embodiment.

### DETAILED DESCRIPTION

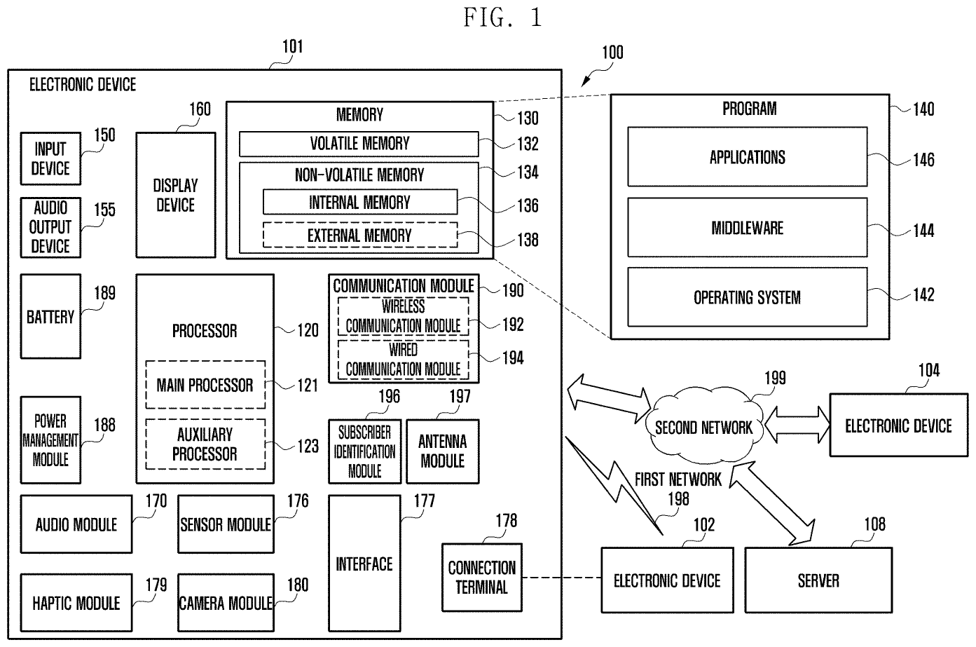

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 is a block diagram of an electronic device 101, or user terminal 101, in a network environment 100, controlling a connection of an external device, according to certain embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, an audio output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard or a digital pen (e.g., a stylus pen).

The audio output device 155 may output sound signals to the outside of the electronic device 101. The audio output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the audio output device 155 or a headphone of an external electronic device (e.g., an electronic device 102) (e.g., speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) (e.g., a wireless transceiver) or a wired communication module 194 (e.g., a local area network (LAN) communication module or a power line communication (PLC) module) (e.g., a wired transceiver). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element implemented by a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

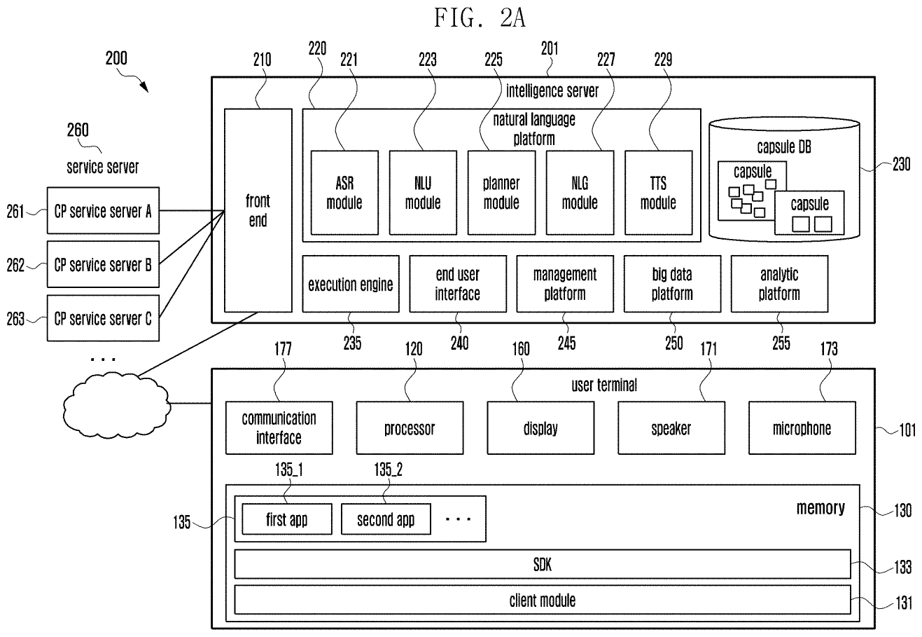

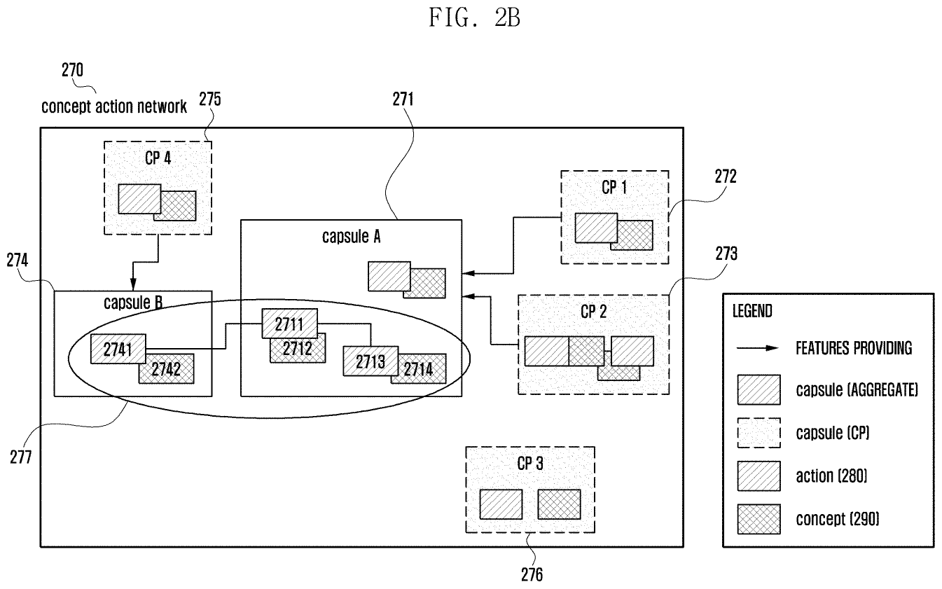

FIG. 2A is a block diagram illustrating a configuration of an integrated intelligence system 200 according to various embodiments.

In the embodiment of FIG. 2A, the integrated intelligence system 200 may include a user terminal 101, an intelligence server 201, and a service server 260.

According to an embodiment, the user terminal 101 may be a terminal device (or electronic device) that is capable of accessing the Internet; examples of the user terminal 101 include a portable phone, a smartphone, a personal digital assistant (PDA), a laptop computer, a television (TV), a white appliance, a wearable device, a head-mounted display (HMD), and a smart speaker. In some embodiments, the user terminal 101 can be the electronic device 101.

According to an embodiment, the user terminal 101 may include the communication interface 177, the microphone 173, the speaker 171, the display 160, the memory 130, and/or the processor 120. The above-enumerated components may be operationally or electrically connected with each other.

According to an embodiment, the communication interface 177 may be configured to connect to an external device (e.g., electronic devices 102 and 104 in FIG. 1) and a server for data communication. According to an embodiment, the microphone 173 may receive sound (e.g., user's utterance) and convert the sound to an electrical signal. According to an embodiment, the speaker 171 may convert an electrical signal to sound (e.g., speech). According to an embodiment, the display 160 may be configured to display an image or a video. According to an embodiment, the display 160 may also display a graphic user interface (GUI) of an application (app) or application program.

According to an embodiment, the memory 130 may store a client module 131, a software development kit (SDK) 133, and applications 135. The client module 131 and the SDK 133 may form a framework (or solution program) for executing a universal function. The client module 131 may also form a framework for processing a speech input.

According to an embodiment, the applications 135 stored in the memory 130 may be programs for executing predetermined functions. According to an embodiment, the applications 135 may include first app 135_1 and second app 135_2. According to an embodiment, the applications 135 may include a plurality operations being executed to perform corresponding functions. For example, the applications 135 may include at least one of an alarm app, a messaging app, and a schedule app. According to an embodiment, the applications 135 may be executed by the processor 120 to perform at least some of the operations in order.

According to an embodiment, the processor 120 may control overall operations of the user terminal 101. For example, the processor 120 may be electrically connected to the communication interface 177, the microphone 173, the speaker 171, the display 160, and the memory 130 to perform predetermined operations.

According to an embodiment, the processor 120 may execute a program stored in the memory 130 to perform a predetermined function. For example, the processor 120 may execute at least one of the client module 131 or the SDK 133 to perform an operation for processing a speech input as to be described hereinbelow. For example, the processor 120 may control operations of the applications 135 via the SDK 133. The operations being described hereinbelow as of the client module 131 or the SDK 133 may be the operations executed by the processor 120.

According to an embodiment, the client module 131 may receive a speech input. For example, the client module 131 may receive a speech signal corresponding to a user's utterance detected through the microphone 173. The client module 131 may transmit the received speech input to the intelligence server 201. According to an embodiment, the client module 131 may transmit state information of the user terminal 101 along with the received speech input to the intelligence server 201. The state information may be an application execution state by way of example.

According to an embodiment, the client module 131 may receive a result corresponding to the received speech input. For example, the client module 131 may receive the result corresponding to the speech input from the intelligence server 201. The client module 131 may display the received result on the display 160.

According to an embodiment, the client module 131 may receive a plan corresponding to the received speech input. The client module 131 may display operation execution results of multiple applications on the display 160 according to the plan. For example, the client module 131 may display the execution results of multiple operations in order on the display 160. By way of another example, the user terminal 101 may display just some of the multiple operation execution results (e.g., last operation results) on the display 160.

According to an embodiment, the client module 131 may receive a request for information used for acquiring a result corresponding to speech recognition from the intelligence server 201. For example, the information used for accruing the result may be state information of the user terminal 101. According to an embodiment, the client module may transmit information corresponding to the request to the intelligence server 201.

According to an embodiment, the client module 131 may transmit information on the execution results of the multiple operations to the intelligence server 201 according to the plan. The intelligence server 201 may verify that the speech input has been correctly processed based on the information of the execution results.

According to an embodiment, the client module 131 may include a speech recognition module (not shown). According to an embodiment, the client module 131 may recognize a speech input for executing a predetermined function via the speech recognition module (not shown). For example, the client module 131 may execute an intelligence application for processing a speech input for an interactive operation that is supposed to be executed by a predetermined input (e.g., wakeup!).

According to an embodiment, the intelligence server 201 may receive information on the user's speech input from the user terminal 101 through a communication network. According to an embodiment, the intelligence server 201 may convert data related to the received user's speech input to text data. According to an embodiment, the intelligence server 201 may generate a plan for executing a task corresponding to the user's speech input based on the text data.

According to an embodiment, the plan may be generated by an artificial intelligence (AI) system. The AI system may be a rule-based system or a neural network-based system (e.g., feedforward neural network (FNN) and recurrent neural network (RNN)). The AI system may also be a combination of the aforementioned systems or another AI system. According to an embodiment, the plan may be selected from a set of predefined plans or generated in real time in response to a user's request. For example, the AI system may select one of a plurality of predefined plans.

According to an embodiment, the intelligence server 201 may transmit a result produced based on the generated plan or the generated plan itself to the user terminal 101. According to an embodiment, the user terminal 101 may display the result produced by the plan on the display 160. According to an embodiment, the user terminal 101 may display the operation execution result produced by the plan on the display 160.

According to an embodiment, the intelligence server 201 may include a front end 210, a natural language platform 220, a capsule database (DB) 230, an execution engine 235, an end user interface 240, a management platform 245, a big data platform 250, and an analytic platform 255.

According to an embodiment, the front end 210 may receive a speech input from the user terminal 101. The front end 210 may transmit a response in reply to the speech input.

According to an embodiment, the natural language platform 220 may include an automatic speech recognition (ASR) module 221, a natural language understanding (NLU) module 223, a planner module 225, a natural language generator (NLG) module 227, and/or a text-to-speech (TTS) module 229.

According to an embodiment, the ASR module 221 may convert the speech input received from the user terminal to text data. According to an embodiment, the NLU module 223 may understand a user's intent based on the text data of the speech input. For example, the NLU module 223 may understand the user's intent by performing a syntactic analysis or semantic analysis. According to an embodiment, the NLU module 223 may understand the meanings of words extracted from the speech input based on linguistic characteristics (e.g., grammatical elements) of morphemes or phrases and determine a user's intent by matching the meanings of the understood words to an intent.

According to an embodiment, the planner module 225 may generate a plan based on the intent determined by the NLU module 223 and parameters. According to an embodiment, the planner module 225 may determine multiple domains used for executing a task based on the determined intent. The planner module 225 may determine multiple operations included in each of the multiple domains based on the intent. According to an embodiment, the planner module 225 may determine a parameter used for executing the multiple operations and a result value to be output as a consequence of the execution of the multiple operations. The parameter and result value may be defined as a concept related to a predetermined format (or class). Accordingly, the plan may include multiple operations and concepts determined based on the user's intent. The planner module 225 may determine relationships between the multiple operations and multiple concepts in a stepwise (hierarchical) manner. For example, the planner module 225 may determine an execution order of the multiple operations determined based on the user's intent according to the multiple concepts. That is, the planner module 225 may determine the execution order of the multiple operations based on the parameter used for executing the multiple operations and the result output as a consequence of the executions of the multiple operations. The planner module 225 may generate a plan including information on the relationship (e.g., ontology) between the multiple operations and the multiple concepts. The planner module 225 may generate the plan by using the information stored in the capsule DB 230, which stores a set of relationships between the concepts and operations.

According to an embodiment, the NLG module 227 may convert designated information to a text format. The information converted to the text formation may be a format of a natural language utterance. According to an embodiment, the TTS module 229 may convert the information in the text format to information in a speech format.

According to an embodiment, the capsule DB 230 may store the information on the relationships between the multiple concepts corresponding to multiple domains and the operations. For example, the capsule DB 230 may store multiple action objects (or action information) of the plan and concept objects (or concept information). According to an embodiment, the capsule DB 230 may store multiple capsules in the form of a concept action network (CAN). According to an embodiment, the multiple capsules may be stored in a function registry included in the capsule DB 230.

According to an embodiment, the capsule DB 230 may include a strategy registry storing strategy information for use in determining a plan corresponding to the speech input. The strategy information may include reference information for determining a plan in case of multiple plans corresponding to the speech input. According to an embodiment, the capsule DB 230 may include a follow-up registry storing follow-up operation information for proposing a follow-up operation to the users in a predetermined situation. For example, the follow-up operation may include a follow-up utterance. According to an embodiment, the capsule DB 230 may include a layout registry storing layout information of the information output by the user terminal 101. According to an embodiment, the capsule DB 230 may include a vocabulary registry storing vocabulary information included in the capsule information. According to an embodiment, the capsule DB 230 may include a dialog registry storing dialogs (or interactions) with the user.

According to an embodiment, the capsule DB 230 may update objects stored via a developer tool. For example, the developer tool may include a function editor for updating the operation objects or concept objects. The developer tool may include a vocabulary editor for updating vocabulary. The developer tool may include a strategy editor for generating and registering a strategy for determining a plan. The developer tool may include a dialog editor for generating a dialog with the user. The developer tool may include a follow-up editor for activating a follow-up goal and editing a follow-up utterance providing a hint. The follow-up goal may be determined based on a current goal, a user's preference, or an environmental condition.

According to an embodiment, the capsule DB 230 may be implemented in the user terminal 101. That is, the user terminal 101 may include the capsule DB 230 storing information for use in determining an operation corresponding to a speech input.

According to an embodiment, the execution engine 235 may produce a result based on the generated plane. According to an embodiment, the end user interface 240 may transmit the produced result to the user terminal 101. The user terminal 101 may receive the result and provide the user with the received result. According to an embodiment, the management platform 245 may manage information in use by the intelligence server 201. According to an embodiment, the big data platform 250 may collect user data. According to an embodiment, the analysis platform 255 may manage quality of service (QoS) of the intelligence server 201. For example, the analysis platform 255 may manage the components and processing speed (or efficiency) of the intelligence server 201.

According to an embodiment, the service server 260 may provide the user terminal 101 with a predetermined service (e.g., food order or hotel reservation). According to an embodiment, the service server 260 may be a third-party server. For example, the service server 260 may include a first service server 261, a second service server 262, and a third service server 263 that are operated by different third parties. According to an embodiment, the service server 260 may provide the intelligence server 201 with information for use in generating a plan corresponding to the received speech input. For example, the provided information may be stored in the capsule DB 230. The service server 260 may also provide the intelligence server 201 with information on the result being producible by the plan.

In the above-described integrated intelligence system 200, the user terminal 101 may allow the user to make an input for use of various intelligence services. Examples of the user input may include an input made via a physical button, a touch input, or a speech input.

According to an embodiment, the user terminal may allow the user to use a speech recognition service via an intelligent application (or speech recognition application) stored inside. In this case, the user terminal 101 may recognize a user's utterance or voice input through the microphone 173 and enable the user to consume the service being provided in response to the user's utterance.

According to an embodiment, the user terminal 101 may execute a predetermined operation independently or in interaction with the intelligence server 201 and/or the service server 260 based on the received speech input. For example, the user terminal 101 may execute an application to carry out a predetermined operation in response to the received speech input.

According to an embodiment, in the case where the user terminal 101 cooperates with the intelligence server 201 and/or the service server 260 to provide a service, the user terminal 101 may detect a user's utterance by means of the microphone 173 and generate a signal (or speech data) corresponding to the detected user's utterance. The user terminal 101 may transmit the speech data to the intelligence server 201 via the communication interface 177.

According to an embodiment, the intelligence server 201 may generate a plan for executing a task corresponding to the speech input received from the user terminal 101 or produce a result as a consequence of task execution. For example, the plan may include a plurality of operations for executing the task corresponding to the user's speech input and a plurality of concepts related to the operations. The concepts may be of defining parameters input for execution of multiple operations and result values produced as a consequence of the execution of the operations. The plan may include relationships between the operations and the concepts.

According to an embodiment, the user terminal 101 may receive the response via the communication interface 177. The user terminal 101 may output a speech signal generated inside the user terminal 101 via the speaker 171 or an image generated inside the user terminal 101 via the display 160.

FIG. 2B is a diagram illustrating a configuration of a database storing information on a relationship between concepts and operations according to various embodiments.

A capsule DB (e.g., capsule DB 230 in FIG. 2A) of an intelligence server (e.g., intelligence server 201 in FIG. 2A) may store capsules in the form of a concept action network (CAN) 270. The capsule DB may store an operation for processing a task corresponding to a user's speech input and parameters used for the operations in the form of a CAN. The CAN may show a systematic relationship between the operations (actions) and the concepts defining parameters used for execution of the operations.

The capsule DB may store multiple capsules (e.g., capsule A 271 and capsule B 274) corresponding to multiple domains (e.g., applications). According to an embodiment, a capsule (e.g., capsule A 271) may correspond to a domain (e.g., application). A capsule may also correspond to at least one service provider (CP) (e.g., CP 1 272, CP 2 273, CP 3 276, or CP 4 275) for executing a function of the domain related to the capsule. According to an embodiment, a capsule may include at least one action and at least one concept for executing a predetermined function.

According to an embodiment, a natural language platform (e.g. natural language platform 220 in FIG. 2A) may generate a plan for executing a task corresponding to a received speech input using a capsule stored in the capsule DB. For example, a planner module (e.g., planner module 225 in FIG. 2A) of the natural language platform may generate a plan using a capsule stored in the capsule DB. For example, the planner module 225 may generate the plan 277 with the actions 2711 and 2713 and the concepts 2712 and 2714 included in capsule A 271 and the action 2741 and the concept 2742 included in capsule B 274.

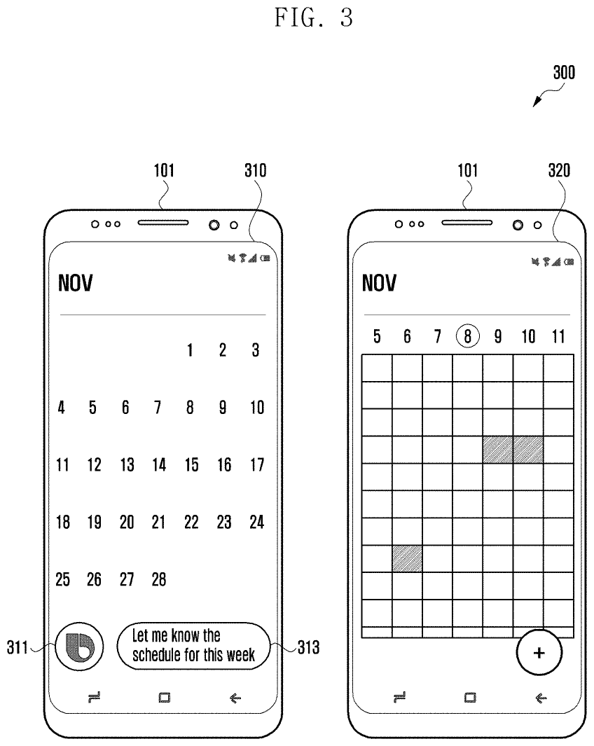

FIG. 3 is a diagram 300 illustrating screen displays for explaining a procedure for a user terminal to process a speech input via an intelligence application according to various embodiments.

The user terminal 101 may execute an intelligence application for processing a user input via the intelligence server 201.

According to an embodiment, the user terminal 101 may execute an intelligence application for processing a speech input upon receipt of a designated speech input (e.g., wakeup!) or a key input made with a hardware key (e.g., dedicated hardware key) in the state of displaying a screen 310. For example, the user terminal 101 may execute the intelligence application in the state where a scheduling application is running. According to an embodiment, the user terminal 101 may display an object (e.g., icon) 311 corresponding to the intelligence application. According to an embodiment, the user terminal 101 may receive a speech input of a user's utterance. For example, the user terminal 101 may receive a speech input “Let me know the schedule for this week!” According to an embodiment, the user terminal 101 may display a user interface (UI) 313 (e.g., input window) of the intelligence application in which text data corresponding to the received speech input is presented.

According to an embodiment, the user terminal 101 may display a result corresponding to the received speech input on the display as denoted by reference number 320. For example, the user terminal 101 may receive a plan corresponding to the received user input and display the schedule for this week according to the plan.

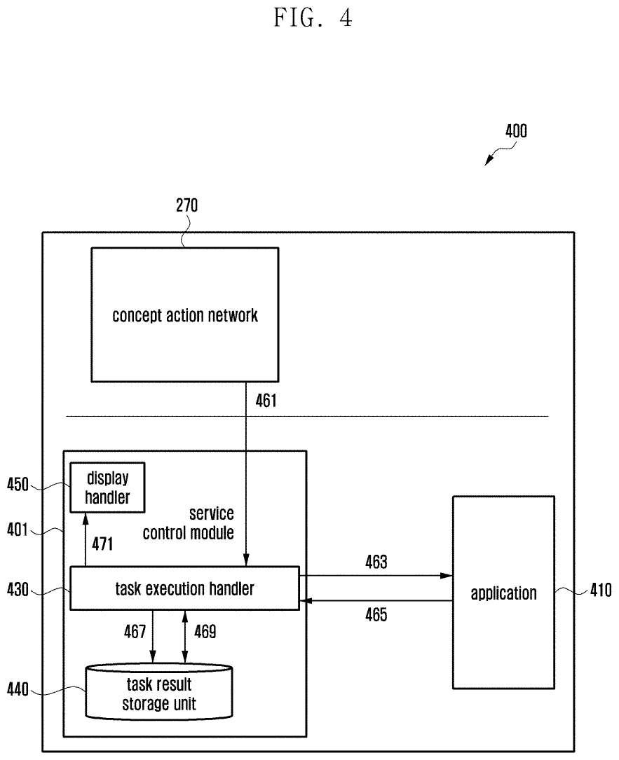

FIG. 4 is a block diagram 400 illustrating signal flows among a concept action network, a service control module, and an application according to various embodiments.

In reference to FIG. 4, the concept action network (CAN) 270 may send a plan for executing a task and task execution result notification information to a task execution handler 430 of the service control module 401. For example, the task execution result notification information may be displayed based on at least one data related to the notification information. The at least one data may include content of the task execution result notification information (e.g., notification content output after execution of the task and notification content output after execution failure) and/or a notification information display format (e.g., popup window (e.g., mini view) display format, overlay display format, and interactive display format).

According to an embodiment, the task execution handler 430 of the service control module 401 may execute a task with the application 410 based on the plan for executing the task as denoted by reference number 463 and receive an execution result from the application 410 as denoted by reference number 465.

According to an embodiment, the task execution handler 430 of the service control module 401 may store the content of the notification information and the notification information display format in the task result storage unit 440 as denoted by reference number 467. After executing the task, the task execution handler 430 of the service control module 401 may retrieve the notification information content and notification information display format matching the task execution result from the task result storage unit 440 as denoted by reference number 469. The task execution handler 430 of the service control module 401 may send the notification information content and notification information display format matching the task execution result to the display handler 450 as denoted by reference number 471 to output the task execution result notification information.

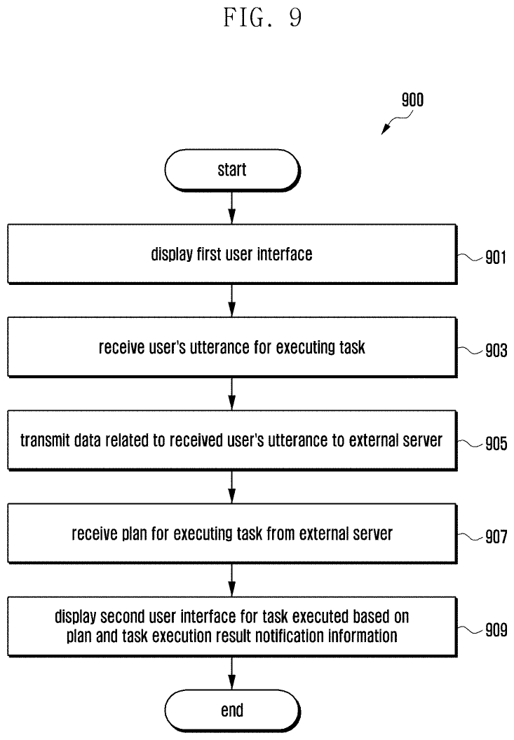

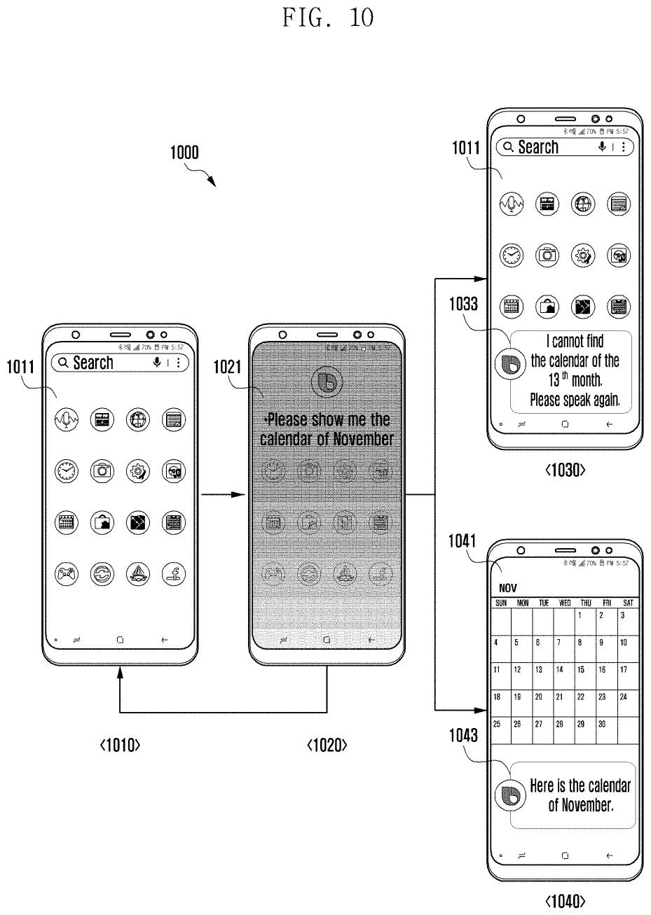

The task execution result notification information output operation in FIG. 4 is described in more detail later with reference to FIGS. 9 and 10.

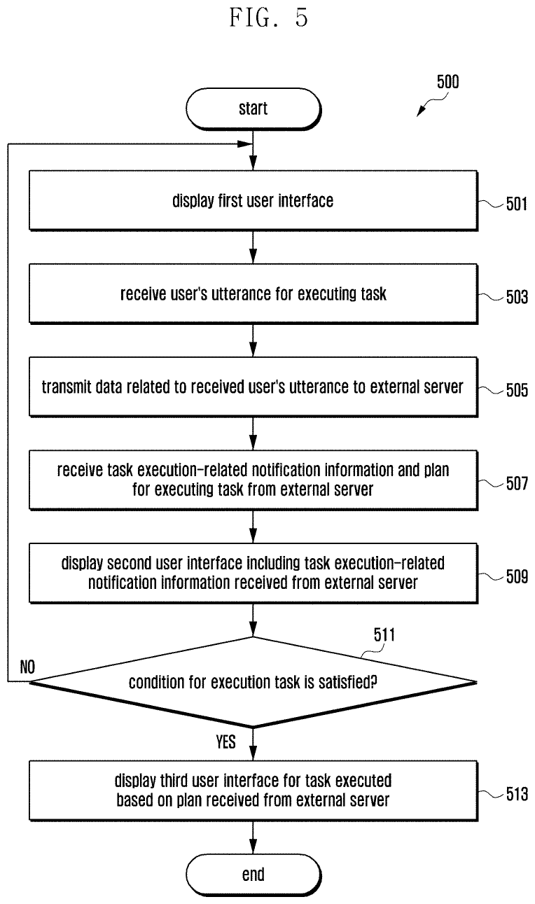

FIG. 5 is a flowchart 500 illustrating an operation-related notification procedure of a speech recognition function-equipped electronic device according to an embodiment.

In reference to FIG. 5, the electronic device (e.g., electronic device 101 in FIG. 1) may display a first user interface on a display (e.g., display device 160 in FIG. 1) at operation 501. Examples of the first user interface may include at least one application execution screen, a home screen including a plurality of icons corresponding to a plurality of applications, or a lock screen. However, the first user interface is not limited to the enumerated screens.

According to an embodiment, the electronic device 101 may receive, at operation 503, a user's utterance (or speech input) for executing a task. For example, the electronic device 101 may execute an intelligence application (or speech recognition application) for processing the user's utterance. If the electronic device 101 detects a designated input, it may execute an intelligence application for the user's utterance. The designated input may be at least one of an input made by pressing a physical key that is separately provided on the electronic device 101, a designated speech (e.g., wakeup) input made through a microphone (e.g., microphone 173 in FIG. 2A), or an input made by selecting an icon displayed on a display 160 to execute the speech recognition function. While the intelligence application is running, the electronic device 101 may receive a user's utterance. For example, the user's utterance may be an input for executing a task with a specific application via the speech recognition function.

According to an embodiment, the electronic device 101 may receive a speech input for executing a task with an application (e.g., signal application or multiple applications) of which an execution screen is displayed on the display 160 or a user's utterance for executing a task with an application different from the application of which the execution screen is displayed on the display 160.

According to an embodiment, the electronic device 101 may transmit, at operation 505, data related to the user's utterance to an external server (e.g., intelligence server 201 in FIG. 2A).

According to an embodiment, the electronic device 101 may receive, at operation 507, task execution-related notification information and a plan for executing the task from the external server (e.g., intelligence server 201 in FIG. 2A).

According to an embodiment, the task execution-related notification information may include information on an operation for executing the task corresponding to the user's utterance. The task execution-related notification information may be generated by a CAN (e.g., CAN 270 in FIG. 2B). The CAN 270 may transmit the generated task execution-related notification information to the external server (e.g., intelligence server 201 in FIG. 2A). The electronic device 101 may receive the task execution-related notification information generated by the CAN 270 from the intelligence server 201.

According to an embodiment, the electronic device 101 may display the task execution-related notification information based on at least one data related to the notification information. The at least one data may include at least one of information on whether to provide notification information, notification information content, notification information output mode (e.g., display on the display 160 and output through a speaker (e.g., speaker 171 in FIG. 2A), notification information display format (e.g., mini view format, overlay format, and interactive format) on a second user interface (e.g., 631 or 833), notification information provision timing (e.g., before or after task execution), or whether task canceling is allowed.

According to an embodiment, the plan for executing the task may include at least one operation for executing the task corresponding to the user's utterance and at least one concept related to the at least one operation. For example, the planner module 225 of the natural language platform (e.g., natural language platform 220) of the intelligence server 201 may generate a plan for executing a task corresponding to the received speech input using a capsule stored in a capsule DB (e.g., capsule DB 230 in FIG. 2A). The electronic device 101 may receive the plan generated by the planner module 225 for executing the task from the intelligence server 201.

According to an embodiment, the electronic device 101 may display, at operation 509, the second user interface including the task execution-related notification information received from an external server (e.g., intelligence server 201 in FIG. 2A). For example, the electronic device 101 may output the notification information related to the operation for executing a task corresponding to the received user's utterance before executing the task. For example, the electronic device 101 may output notification information related to an operation for executing the task through the display 160 or the audio module 170 in the form of speech. Outputting the notification information on the operation for executing the task may allow the user to intuitively notice whether the user's utterance is correctly recognized.

According to an embodiment, the electronic device 101 may determine at operation 511 whether a designated condition for executing the task is satisfied. For example, the predetermined condition may include at least one of elapse of a designated time period after displaying the second user interface, detection of a user input for selecting a designated button, or receipt of a designated user's utterance through the microphone 173.

According to an embodiment, if the designated condition for executing the task is satisfied, the electronic device 101 may display, at operation 513, a third user interface for the task executed based on the plan received from the external server (e.g., intelligence server 201 in FIG. 2A). For example, the third user interface may include a screen displaying an execution result of at least one operation with the application according to the plan.

According to an embodiment, if the designated condition is satisfied, e.g., if the designated time period (e.g., n seconds) elapses after displaying the second user interface, the electronic device 101 may display the third user interface for the task executed based on the plan received from the external server (e.g., intelligence server 201 in FIG. 2A).

According to an alternative embodiment, the second user interface including the task execution-related notification information may include a confirm button for confirming the execution of the task and a cancel button for canceling the execution of the task. If a user input for selecting the confirm button is detected, the electronic device 101 may determine that the designated condition for executing the task is satisfied and display the third user interface for the task executed based on the plan. If a user input for selecting the confirm button provided in the second user interface is detected, the electronic device 101 may determine that the user's utterance is correctly recognized.

According to an alternative embodiment, if a designated user's utterance (e.g., please execute) for executing the task is input through the microphone 173 after displaying the second user interface, the electronic device 101 may display the third user interface for the task executed based on the plan received from the external server (e.g., intelligence server 201 in FIG. 2A).

According to an embodiment, if the designated condition for executing the task is not satisfied, the procedure goes back to operation 501 to display the first user interface.

According to an embodiment, if a user input for selecting the cancel button provided in the second user interface is detected, the electronic device 101 may determine that the designated condition is not satisfied and display the first user interface at operation 501. For example, if a user input for selecting the cancel button provided in the second user interface is detected, the electronic device may determine that the user's utterance is not correctly recognized.

According to an alternative embodiment, if a user's utterance (e.g., please cancel) designated for canceling the task is received through the microphone 173 after displaying the second user interface, the electronic device 101 may determine that the user's utterance is not correctly recognized and display the first user interface at operation 501.

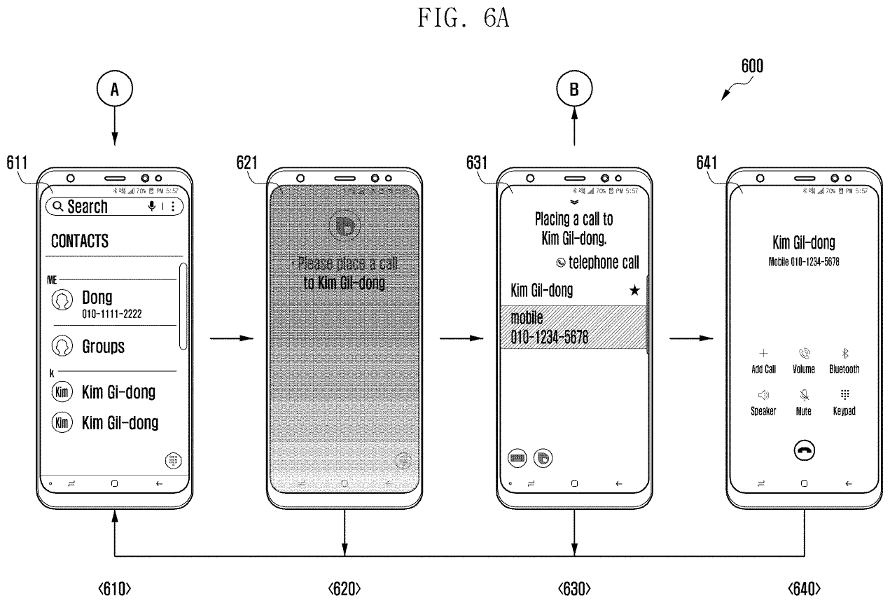

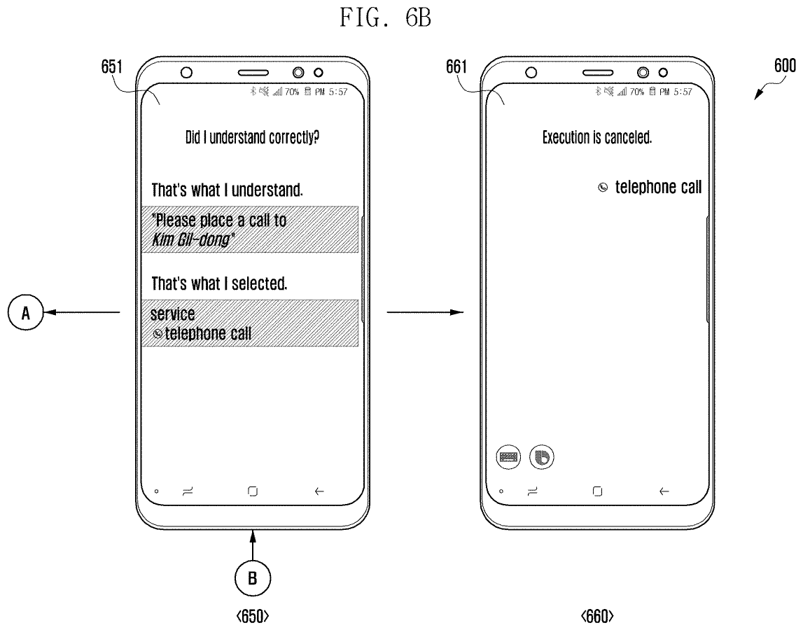

FIGS. 6A and 6B are a diagram 600 illustrating screen displays for explaining an operation-related notification method of a speech recognition function-equipped electronic device according to an embodiment.

In the embodiment of FIGS. 6A and 6B, the description is made under the assumption that a call is placed to a certain user while a contacts application execution screen 611 is displayed.

In reference to FIGS. 6A and 6B, the electronic device (e.g., electronic device 101 in FIG. 1) may display a first user interface, e.g., contacts application execution screen 611, on a display (e.g., display 160 in FIG. 2A) as denoted by reference number 610.

According to an embodiment, if the electronic device 101 detects a designated signal input (e.g., input made by pressing a physical key that is separately provided on the electronic device 101, designated speech (e.g., wakeup) input made through a microphone (e.g., microphone 173 in FIG. 2A), or input made by selecting an icon displayed on the display 160 to execute the speech recognition function), it may execute an intelligence application (or speech recognition application) for processing the user's utterance as denoted by reference number 620. The electronic device 101 may receive a user's utterance while the intelligence application is running. The electronic device 101 may display a user interface 621 related to the user's utterance recognized by the intelligence application on the display 160. For example, the electronic device 101 may recognize the user's utterance “Please place a call to Kim Gil-dong.” input while the intelligence application is running and display the user interface 621 including the recognized user's utterance.

According to an embodiment, the electronic device 101 may transmit data related to the user's utterance to an external server (e.g., intelligence server 201 in FIG. 2A).

According to an embodiment, the electronic device 101 may receive task execution-related notification information from the external server (e.g., intelligence server 201 in FIG. 2A) and display a user interface 631 including the received task execution-related notification information as denoted by reference number 630. For example, the electronic device 101 may display information on the operation for executing a task corresponding to the user's utterance, e.g., “Please place a call to Kim Gil-dong”, before executing the task. Outputting the notification information on the operation for executing the task may allow the user to intuitively notice whether the user's utterance is correctly recognized.

According to an embodiment, if the electronic device 101 detects an input for terminating the task while the user interface 621 including the user's utterance or the user interface 631 including the task execution-related notification information is displayed, it may stop executing the task corresponding to the user's utterance and display the first user interface, e.g., contacts application execution screen 611.

According to an embodiment, the electronic device 101 may further receive a plan for executing the task along with the task execution-related notification information from an external server (e.g., intelligence server 201 in FIG. 2A).

According to an embodiment, after the user interface 631 including the task execution-related notification information is displayed, if a designated condition is satisfied, e.g., if a designated time period elapses or if a user input for executing an operation corresponding to the user's utterance (e.g., user input for selecting a confirm button provided in the user interface 631 or user input of a designated user's utterance (e.g., please execute) made through the microphone (e.g., microphone 173 in FIG. 2A) is detected, the electronic device may execute an operation corresponding to the task based on a plan for executing the task received from the external server (e.g., intelligence server 201 in FIG. 2A) as denoted by reference number 640. For example, the electronic device 101 may execute a telephone application based on the plan and display a user interface 641 showing a process of placing a call to Kim Gil-dong via the telephone application.

According to an embodiment, if the call placed to Kim Gil-dong is terminated, the electronic device 101 may display the first user interface, e.g., contacts application execution screen 611.

According to an alternative embodiment, if the call placed to Kim Gil-dong is terminated, the electronic device 101 may display the user interface 631 including the task execution-related notification information. For example, the electronic device may store the task execution-related notification information and, depending on whether the task execution-related notification information is stored, display the contacts application execution screen 611 or the user interface 631 including the task execution-related notification information.

According to an embodiment, if the electronic device 101 detects a predetermined gesture while the user interface 631 including the task execution-related notification information is displayed as denoted by reference number 630, it may display a user interface 651 including detailed information on the task execution as denoted by reference number 650. For example, the predetermined gesture may include a swipe gesture made on the display displaying the user interface 631 in a predetermined direction (e.g., from bottom to top on the display). However, the predetermined gesture is not limited thereto, and the electronic device 101 may display the user interface 651 including the detailed information on the task execution in response to a user input for selecting a button (not shown) provided in the user interface 631 to display the user interface 651.

According to an embodiment, if the electronic device 101 detects a predetermined gesture while the user interface 631 is displayed, it may determine not to perform the task corresponding to the user's utterance and may display the user interface including the detailed information on the task execution.

According to an embodiment, the user interface 651 being displayed in response to the detection of the predetermined gesture may include a phrase asking whether the user's utterance is correctly recognized (e.g., Did I understand correctly?), the recognized user's utterance (e.g., Please place a call to Kim Gil-dong), and/or an operation (sequence) (e.g., telephone call) to be performed in response to the user's utterance.

According to an embodiment, the electronic device 101 may detect an input for changing the operation to be executed on the user interface 651. For example, if the electronic device 101 detects a user input for selecting the operation (e.g., telephone call) to be performed in response to the user's utterance included in the user interface 651, it may display a list of operations executable in response to the user's utterance (e.g., “Please place a call to Kim Gil-dong”). For example, the list of the operations executable in response to the user's utterance may include telephone call, text messaging, and voice call via a third party service. If an operation is selected from the operation list, the electronic device may display the user interface 621 about the user's utterance before executing a task corresponding to the user's utterance with the selected operation.

According to an embodiment, if the electronic device 101 detects a predetermined gesture made in a predetermined direction while the user interface 651 including the detailed information on the task execution is displayed, it may display a user interface 661 showing that the task execution is canceled as denoted by reference number 660. For example, the predetermined gesture may include a swipe gesture made on the display in a predetermined direction (e.g., from top to bottom on the display) while the user interface 651 is displayed. However, the predetermined gesture is not limited thereto.

According to an embodiment, if the electronic device 101 detects an input for terminating the task while the user interface 651 including the detailed information on the task execution, it may display the first user interface, e.g., contacts application execution screen 611.

According to an embodiment, providing the user with the user interfaces 631 and 651 including the task execution-related notification information allows the user to notice whether the user's utterance is correctly recognized. According to an embodiment, providing the user with the list of operations executable in response to the user input detected in the user interface 651 including the detailed information on the task execution allows the user to select an operation from the list to be executed in response to the user's utterance.

According to an embodiment, if a predetermined condition is satisfied while the user interface 631 is displayed, e.g., if a user input for canceling the operation corresponding to the user's utterance (e.g., user input selecting a cancel button provided in the user interface 651 or user input of a designated user's utterance (e.g., Please cancel) made through the microphone (e.g., microphone 173 in FIG. 2A)) is detected, the electronic device 101 may display the user interface 661 showing that the task execution is canceled as denoted by reference number 660.

According to an alternative embodiment, if the electronic device 101 detects an input for canceling the operation corresponding to the user's utterance while the user interface 631 is displayed, it may stop executing the task corresponding to the user's utterance and display the first user interface, e.g., contacts application executing screen 611.

According to an embodiment, if a predetermined condition is satisfied while the user interface 631 is displayed, e.g., if an input for canceling the operation corresponding to the user's utterance (e.g., user input for selecting a cancel button provided in the user interface 651 or user input of a designated user's utterance (e.g., Please cancel) made through the microphone (e.g., microphone 173 in FIG. 2A)) is detected, the electronic device 101 may stop executing the task corresponding to the user's utterance and display the first user interface, e.g., contacts application execution screen 611.

In the embodiment of FIGS. 6A and 6B, it may be possible to provide the user with the task execution-related notification information before executing a task through an algorithm as shown in Table 1. For example, the electronic device 101 may determine to provide the user with notification (e.g., notification: “true”) and, if a user's utterance, e.g., “Please place a call to Kim Gil-dong.”, is received, display the user interface 631 including a notification message (e.g., “Placing a call to Kim Gil-dong.”) in a predetermined notification view format (e.g., capsule view in which the task execution-related notification information is semi-transparently displayed on the user interface 621 in an overlay manner) before executing the task (e.g., notification provision timing) based on the algorithm as shown in Table 1.

According to an embodiment, in the case where the electronic device 101 is configured to provide the notification in the form of TTS, the electronic device 101 may convert the text “Placing a call to Kim Gil-dong.” to speech data, which is output through the speaker (e.g., speaker 171 in FIG. 2A).

According to an embodiment, if the electronic device 101 detects an input designated for canceling a task, it may display the user interface 661 including “Execution is canceled.” (e.g., notification message updated upon canceling of the task).

According to an embodiment, in the case where the electronic device 101 is configured to recognize speech corresponding to a predetermined command, if a designated user's utterance (e.g., Please cancel) for canceling a task is detected, the electronic device 101 may recognize the user's utterance and display the user interface 661 including “Execution is canceled.” (e.g., notification message updated upon canceling of the task).

According to an embodiment, in the case where the electronic device 101 is not configured to maintain a notification after executing a task, the electronic device 101 may display the contacts application execution screen 611 upon termination of the call to Kim Gil-dong.

According to an embodiment, providing the user with the task execution-related notification information before executing a task allows the user to intuitively notice whether the user's utterance is correctly recognized by the electronic device 101. If it is identified that the user's utterance is not correctly recognized by the electronic device 101 based on the task execution-related notification information, the user may cancel the task execution before the user executes the task.

TABLE 1
app_launch{

uri: ″bixby://com.samsung.android.incallui/MakeCall/punchOut?phoneNumber=010-

0123-4567″

notification: ″true″ // whether to provide user with notification
notification_message: ″Placing a call to Kim Gil-dong.″ // Notification message
notification_renderer: {json: ″{\″$type\″:\″ResultDetails...}” // Notification content

(called party information layout)

notification_failure_message: ″Execution is canceled.″ // Notification message

updated when task is canceled

notification_tts_on: ″true″ // whether to use TTS for notification too
notification_view_format: ″capsule_view″ // notification view format
notification_time: ″before_punchOut″ // notification provision timing
notification_view_history: ″false″ // whether to maintain notification even after task

execution

bargein_for_feedback: ″true″ // enable voice command (“cancel”) during notification

}

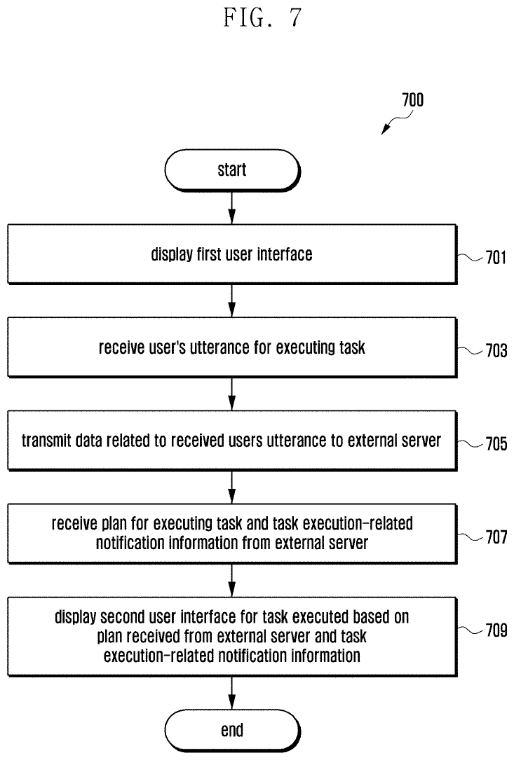

FIG. 7 is a flowchart 700 illustrating an operation-related notification procedure of a speech recognition function-equipped electronic device according to an embodiment.

In the embodiment of FIG. 7, operations 701 to 705 are identical with operations 501 to 505 in FIG. 5; thus, a detailed description thereof is omitted herein.

In reference to FIG. 7, the electronic device (e.g., electronic device 101 in FIG. 1) may display a first user interface on a display (e.g., display 160 in FIG. 1) at operation 701.

According to an embodiment, the electronic device 101 may receive, at operation 703, a user's utterance (e.g., speech input) for executing a task. For example, if a designated input is detected, the electronic device 101 may execute an intelligence application (or speech recognition application) for processing the user's utterance. The electronic device 101 may receive a user's utterance from the user while the intelligence application is running.

According to an embodiment, the electronic device 101 may transmit, at operation 705, data related to the received user's utterance to an external server (e.g., intelligence server 201 in FIG. 2A).

According to an embodiment, the electronic device 101 may receive, at operation 707, a plan for executing the task from the external server (e.g., intelligence server 201 in FIG. 2A) and task execution-related notification information.

According to an embodiment, the plan for executing the task may include at least one operation for executing a task corresponding to the user's utterance and at least one concept related to the at least one operation.

According to an embodiment, the task execution-related notification information may include information on the task executed in response to the user's utterance.

According to an embodiment, the electronic device 101 may display, at operation 709, a second user interface for the task executed based on the plan received from the external server (e.g., intelligence server 201 in FIG. 2A) and the task execution-related notification information. For example, the second user interface may include a screen displaying an execution result of at least one operation executed with an application according to the plan.

According to an embodiment, the electronic device 101 may display the task execution-related notification information based on at least one data related to the notification information. For example, the at least one data item may include at least one of information on whether to provide notification information, notification information content, notification information output format (e.g., display on the display 160 and output through a speaker (e.g., speaker 171 in FIG. 2A), notification information view format (e.g., mini view format, overlay view format, and conversation view format) on a second user interface, notification information provision timing (e.g., before or after task execution), or information on whether task canceling is allowed).

According to an embodiment, the task execution-related notification information may be semi-transparently displayed on the second user interface in an overlay manner. However, the view format is not limited thereto, and the task execution-related notification information may be displayed in a popup window or output through a speaker (e.g., speaker 171 in FIG. 2A).

According to an embodiment, providing the user with the task execution-related notification information allows the user to intuitively notice the executed operation.

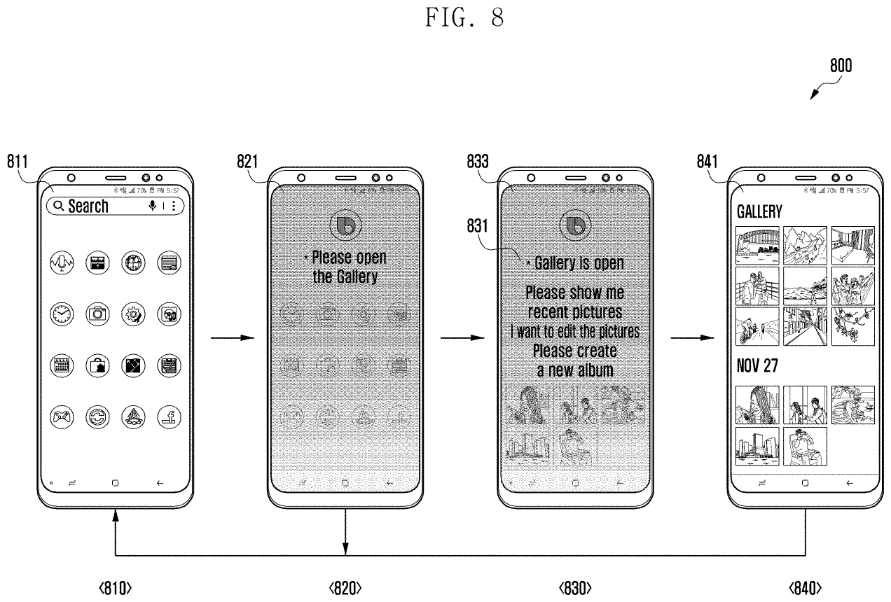

FIG. 8 is a diagram 800 illustrating screen displays for explaining an operation-related notification method of a speech recognition function-equipped electronic device according to an embodiment.

In the embodiment of FIG. 8, the description is made under the assumption that a gallery application is executed in response to a user's utterance input while a screen 811 including at least one icon (e.g., application icon) is displayed.

In reference to FIG. 8, the electronic device (e.g., electronic device 101 in FIG. 1) may display a first user interface (e.g., screen 811 including at least one icon (e.g., application icon)) on a display (e.g., display 160 in FIG. 2A) as denoted by reference number 810.

According to an embodiment, the electronic device 101 may execute an intelligence application (or speech recognition application) for processing the user's utterance upon detection of a designated input (e.g., input made by pressing a physical key that is separately provided on the electronic device 101, designated speech (e.g., wakeup) input made through a microphone (e.g., microphone 173 in FIG. 2A), or input made by selecting an icon displayed on the display 160 to execute the speech recognition function) as denoted by reference number 820. The electronic device 101 may receive a user's utterance while the intelligence application is running. The electronic device 101 may display a user interface 821 related to the user's utterance recognized by the intelligence application on the display 160. For example, the electronic device 101 may recognize the user's utterance “Please open the gallery” input while the intelligence application is running and display the user interface 821 including the recognized user's utterance.

According to an embodiment, the electronic device 101 may transmit data related to the received user's utterance to the external server (e.g., intelligence server 201 in FIG. 2A).

According to an embodiment, the electronic device 101 may receive task execution-related notification information along with a plan for executing the task from the external server (e.g., intelligence server 201 in FIG. 2A). The electronic device 101 may execute the task, e.g., gallery application, based on the plan for executing the task that is received from the external server (e.g., intelligence server 201 in FIG. 2A) and display a second user interface 833 including an execution screen of the gallery application and the task execution-related notification information 831, e.g., “Gallery is opened.”, as denoted by reference number 830.

According to an embodiment, the electronic device 101 may further display a user command (e.g., follow-up operation information) related to an operation to be additionally executed by the gallery operation along with the task execution-related notification information. The user command related to the operation to be additionally executed by the gallery operation may aim to recommend and guide the next operation; examples of the user commands to be additionally executed by the gallery application may include “Show me recent pictures”, “I want to edit pictures”, and “Create a new album”.

According to an embodiment, the task execution-related notification information may be semi-transparently displayed on the gallery application execution screen in an overlay manner. However, the display format is not limited thereto, and task execution-related notification information may be displayed in a popup window, text balloon, or a message window or output through the speaker (e.g., speaker 171 in FIG. 2A).

According to an embodiment, if a predetermined time period elapses or a user input for selecting a cancel button is detected after the task execution-related notification information is displayed on the second user interface 833 in the overlay manner, the electronic device may display the gallery application execution screen 841 from which the task execution-related notification information is removed as denoted by reference number 840.

According to an embodiment, if an input for terminating the intelligence application or the display of the gallery application screen 841 is detected, the electronic device 101 may display the screen 811 (e.g., screen including at least one icon (e.g., application icon)) as denoted by reference number 810.

In the embodiment of FIG. 8, it may be possible to provide the user with the task execution-related notification information after executing the task (e.g., notification provision timing) through an algorithm as shown in Table 2. For example, the electronic device 101 may determine to provide the user with a notification (e.g., notification: “true”) and, if a user's utterance, e.g., “Please open the gallery.”, is received, display the user interface 833 including the gallery application execution screen and the task execution-related notification information 831, e.g., “Gallery is open” (e.g., notification message), in a configured notification view format (e.g., conversation view) based on the algorithm as shown in Table 2.

According to an embodiment, in the case where the electronic device 101 is configured to provide notification in TTS, the electronic device 101 may convert the text “Gallery is open” to speech data, which is output through the speaker (e.g., speaker 171 in FIG. 2A).

According to an embodiment, in the case where a user command (e.g., hint action in notification) related to the operation to be additionally executed is configured, the electronic device 101 may display the user interface 833 including “Show me recent pictures.”, “I want to edit pictures.”, and “Create a new album.”.

According to an embodiment, providing the user with the task execution-related notification information after executing the task allows the user to intuitively notice whether the task corresponding to the user's utterance has been correctly executed.

TABLE 2
app_launch{

uri:

″applink://com.sec.android.gallery3d/SEARCH_BY_CATEGORY?KEY_CONTENT_TYPE=i
mage″

notification: ″true″ // Whether to provide user with notification
notification_message: ″Gallery is open.″ // notification message
notification_tts_on: ″true″ // whether to provide notification in TTS
notification_view_format: ″conversation_view″ // Notification view format
notification_time: ″with_punchOut″ // Notification provision timing

notification_hint_actions: “{ // Hint action content in notification
″actions″: “{
“message”: “Show me recent pictures”,
“request”: “nl (\352\456\364\...”,
}”,
″actions″: “{
“message”: “I want to edit pictures”,
“request”: “nl (\352\456\364\...”,
}”,
″actions″: “{
“message”: “Create a new album”,
“request”: “nl (\352\456\364\...”,
}”,
........
}

FIG. 9 is a flowchart 900 illustrating an operation-related notification procedure of a speech recognition function-equipped electronic device according to an embodiment.

In the embodiment of FIG. 9, operations 901 to 905 are identical with operations 501 to 505 in FIG. 5; thus, a detailed description thereof is omitted herein.

In reference to FIG. 9, the electronic device (e.g., electronic device 101 in FIG. 1) may display a first user interface on a display (e.g., display device 160 in FIG. 1) at operation 901.

According to an embodiment, the electronic device 101 may receive, at operation 903, a user's utterance (or speech input) for executing a task. For example, the electronic device 101 may execute an intelligence application (e.g., speech recognition application) for processing the user's utterance upon detection of a designated input. The electronic device 101 may receive the user's utterance while the intelligence application is running.

According to an embodiment, the electronic device 101 may transmit data related to the user's utterance to an external server (e.g., intelligence server 201 in FIG. 2A) at operation 905.

According to an embodiment, the electronic device 101 may receive, at operation 907, a plan for executing the task from the external server (e.g., intelligence server 201 in FIG. 2A). For example, the plan for executing the task may include at least one operation for executing the task corresponding to the user's utterance and at least one concept related to the at least one operation.

According to an embodiment, the electronic device 101 may display, at operation 909, a second user interface for the task executed based on the plan received from the external server (e.g., intelligence server 201 in FIG. 2A) and notification information about a task execution result.

According to an embodiment, the second user interface may include a screen for at least one operation execution result of the application according to the plan.

According to an embodiment, the notification information on the task execution result may include information on whether the task corresponding to the received user's utterance has been executed and/or, if not executed, information on the cause of non-execution. Providing the user with the notification information on the task execution result allows the user to notice whether the operation corresponding to the user's utterance has been correctly executed or has failed and, if so, a failure cause.

According to an embodiment, the electronic device 101 may display the notification information on the task execution result based on at least one data related to the notification information. For example, the at least one data item may include content of the task execution result notification information (e.g., notification content output after execution of the task and notification content output after execution failure) and/or a notification information display format (e.g., mini view display format, overlay display format, and conversation display format).

According to an embodiment, the notification information on the task execution result may be displayed in a popup window, text balloon, or message window. However, the display format of the notification information is not limited thereto, and the task execution-related notification information may be semi-transparently displayed on the second user interface in an overlay manner or output through a speaker (e.g., speaker 171 in FIG. 2A).

FIG. 10 is a diagram 1000 illustrating screen displays for explaining an operation-related notification method of a speech recognition function-equipped electronic device according to an embodiment.

In the embodiment of FIG. 10, the description is made under the assumption that a scheduling application is executed in response to a user's utterance input, while a screen 1011 including at least one icon (e.g., application icon) is displayed, so as to display a month view screen with a specific month.

In reference to FIG. 10, the electronic device (electronic device 101 in FIG. 1) may display a first user interface, e.g., screen 1011 including at least one icon (e.g., application icon) on a display (e.g., display 160 in FIG. 2A) as denoted by reference number 1010.

According to an embodiment, if a designated input is detected, the electronic device 101 may execute an intelligence application (or speech recognition application) for processing a user's utterance as denoted by reference number 1020. The electronic device may receive a user's utterance from the user while the intelligence application is running. The electronic device 101 may display a user interface 1021 in response to the user's utterance recognized by the executed intelligence application. For example, the electronic device 101 may recognize a user's utterance (e.g., “Show me the calendar of November”) while the intelligence application is running, and display the user interface 1021 including the recognized user's utterance on the display 160.

According to an embodiment, if an error occurs in recognizing the user's utterance, e.g., “Show me the calendar of November” the electronic device 101 may not transmit data related to the user's utterance “Shown me the calendar of November” to an external server (e.g., intelligence server 201 in FIG. 2A).

According to an embodiment, the electronic device 101 may provide the user with a notification of task execution failure caused by a recognition error along with the recognition result. For example, if the user's utterance “Show me the calendar of November” is misrecognized as “Show me the calendar of the 13^{th} month”, the electronic device 101 may display on the display 160 a text balloon 1033 saying “I cannot find out the calendar of the 13^{th} month. Please speak again.” as denoted by reference number 1030. For example, the text balloon 1033 showing the notification information about the task execution result may be presented on the screen 1011 including the at least one icon (e.g., application icon) because the task has not been executed as a result of the erroneous recognition of the user's utterance.

According to an embodiment, if the user's utterance, e.g., “Show me the calendar of November”, is correctly recognized, the electronic device 101 may display a second user interface 1401 for the task executed based on a plan for executing a task that is received from an external server (e.g., intelligence server 201 in FIG. 2A) along with notification information 1403 related to a task execution result as denoted by reference number 1040. For example, the electronic device 101 may execute the scheduling application in response to the user's utterance and a screen 1041 having the calendar of November along with the notification information 1043, e.g., “Here is the calendar of November”, related to the task execution result. The notification information 1043 related to the task execution result may be displayed in the form of a text balloon on the scheduling application screen 1401.

According to an embodiment, if the electronic device 101 detects an input for terminating the intelligence application or the display of the screen 1401 of the calendar of November, it may display the screen including the at least one icon (e.g., application icon) as denoted by reference number 1010.

In the embodiment of FIG. 10, it may be possible to provide the user with the notification information related to the task execution result through an algorithm as shown in Table 2. For example, the electronic device 101 may determine to provide the user with a notification (e.g., notification: “true”) and, if a user's utterance, e.g., “Show me the calendar of November”, is received and correctly recognized, execute the scheduling application (e.g., at notification provision timing) and display the screen 1401 including the calendar of November and a message (e.g., task execution success feedback) including notification information 1403 related to the task execution result, e.g., Here is the calendar of November” in the form of a predetermined notification view format (e.g., mini view) based on the algorithm as shown in Table 3.

According to an embodiment, if an error occurs in recognizing the user's utterance (e.g., “Show me the calendar of November” is misrecognized as “Show me the calendar of the 13^{th} month”, the electronic device may display in a predetermined notification view format (e.g., mini view) the text balloon 1033 (e.g., task execution failure-related feedback) saying “I cannot find the calendar of the 13^{th} month. Please speak again.”

According to an embodiment, in the case where the electronic device 101 is configured to provide notification in TTS, the electronic device 101 may convert the text “Here is the calendar of November” 1043 or “I cannot find the calendar of the 13^{th} month. Please speak again” 1033 to speech data, which is output through the speaker (e.g., speaker 171 in FIG. 2A).

According to an embodiment, providing the user with the task execution result-related notification information allows the user to intuitively notice an execution result of the task corresponding to the user's utterance and, if not being executed, the cause of non-execution.

TABLE 3
app_launch{

uri:

″bixby://com.samsung.android.calendar/ViewCalendar/punchOut?startDate=1535760000000&v
iewType=month″

notification: ″true″ // Whether to provide user with notification

notification_tts_on: ″true″ // Whether to provide notification in TTS too

notification_view_format: ″mini_view″ // Notification view format
notification_time: ″after_punchOut″ // Notification provision timing

success_feedback: “{
“success_message_text”: “Here is the calendar of %s month as requested.”,
“success_tts_response”: “{data: ″\b\004\000\000\00..................”}”,
“success_renderer”: “{json: ″{\″$type\″:\″ResultDetails\″,\″result\″:.....”}”,
}”,
failure_feedback: “{
“failure_message_text”: “I cannot find a calendar of the %s month as requested. Please speak
again.”,
“failure_tts_response”: “{data: ″\b\004\000\000\00..................”}”,
“failure_renderer”: “{json: ″{\″$type\″:\″ResultDetails\″,\″result\″: ....”}”,
}”

As described above, the electronic devices according to various embodiments of the disclosure are advantageous in terms of allowing a user to intuitively notice whether the intent of a user's utterance was correctly recognized by the electronic device in such a way of providing the user with information on an execution result of the operation corresponding to the intent of the detected user's utterance. If it is determined that the intent of the user's utterance is misrecognized, the user may cancel execution of the operation.

The electronic devices according to various embodiments of the disclosure are also advantageous in terms of allowing a user to intuitively notice whether an operation intended by a user's utterance is successfully executed and, if not, a reason of execution failure by providing a user with information on the execution result of the operation corresponding to the recognized intent of the user's utterance.

The electronic device according to certain embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a communication circuit;
a display;
a microphone;
a processor operationally connected to the communication circuit, the display, and the microphone; and
a memory operationally connected to the processor and storing instructions that, when executed by the processor, cause the processor to:
display a first user interface on the display,
receive a user's utterance for executing a task through the microphone,
control the communication circuit to transmit data related to the received user's utterance to an external server,
control the communication circuit to receive notification information associated with execution of the task and a plan for executing the task from the external server,
display a second user interface including notification information in association with execution of the task received from the external server on the display, and
display a third user interface for the task executed based on the plan received from the external server on the display based on satisfaction of a condition for executing the task.

2. The electronic device of claim 1, wherein the notification information associated with the execution of the task comprises information on an operation corresponding to the task to be executed to identify a user's intent from the received user's utterance.

3. The electronic device of claim 1, wherein the memory stores instructions that, when executed by the processor, cause the processor to display the notification information associated with the execution of the task based on at least one data related to the notification information, the at least one data comprising at least one of:
information on whether to provide the notification information;
content of the notification information;
an output mode of the notification information;
a display format of the notification information on the second user interface;
a timing for providing the notification information; or
information on whether to enable canceling the task.

4. The electronic device of claim 1, wherein the plan for executing the task comprises at least one operation for executing the task corresponding to the user's utterance and at least one concept related to the at least one operation.

5. The electronic device of claim 1, wherein the condition for executing the task comprises at least one of a condition on whether a designated time period elapses after display of the second user interface, a condition on whether a user input for selecting a designated button included in the second user interface is detected, or a condition on whether a designated user's utterance is received through the microphone.

6. The electronic device of claim 1, wherein the memory stores instructions that, when executed by the processor, cause the processor to:
cancel execution of the task; and
display the first user interface on the display based on the condition for executing the task not being satisfied.

7. The electronic device of claim 1, wherein the memory stores instructions that, when executed by the processor, cause the processor to store the notification information associated with the execution of the task in the memory.

8. The electronic device of claim 1, wherein the memory stores instructions that, when executed by the processor, cause the processor to display the first user interface or the second user interface, based on whether the notification information associated with the execution of the task is stored in the memory, upon detection of a signal for terminating the executed task.

9. An electronic device comprising:
a communication circuit;
a display;
a microphone;
a processor operationally connected to the communication circuit, the display, and the microphone; and
a memory operationally connected to the processor and storing instructions that, when executed by the processor, cause the processor to:
display a first user interface on the display,
receive a user's utterance for executing a task through the microphone,
control the communication circuit to transmit data related to the received user's utterance to an external server,
control the communication circuit to receive a plan for executing the task and notification information associated with execution of the task from the external server, and
display a second user interface for the task executed based on the plan received from the external server and the notification information associated with the execution of the task on the display.

10. The electronic device of claim 9, wherein the memory stores instructions that, when executed by the processor, cause the processor to display information on follow-up operations executable with an application corresponding to the task on the display.

11. The electronic device of claim 9, wherein the notification information associated with the execution of the task comprises information on the task corresponding to an operation executed in response to the user's utterance.

12. The electronic device of claim 10, wherein the memory stores instructions that, when executed by the processor, cause the processor to display of the notification information associated with the execution of the task based on at least one data related to the notification information, the at least one data comprising at least one of:
information on whether to provide the notification information;
content of the notification information;
an output mode of the notification information;
a display format of the notification information on the second user interface;
a timing for providing the notification information; or
information on the follow-up operation.

13. The electronic device of claim 9, wherein the memory stores instructions that, when executed by the processor, cause the processor to display the first user interface on the display upon detection of an input for terminating the task.

14. An electronic device comprising:
a communication circuit;
a display;
a microphone;
a processor operationally connected to the communication circuit, the display, and the microphone; and
a memory operationally connected to the processor and storing instructions that, when executed by the processor, cause the processor to:
display a first user interface on the display,
receive a user's utterance for executing a task through the microphone,
control the communication circuit to transmit data related to the received user's utterance to an external server,
control the communication circuit to receive a plan for executing the task from the external server, and
display a second user interface for the task executed based on the plan received from the external server and notification information on an execution result of the task on the display.

15. The electronic device of claim 14, wherein the notification information on the execution result of the task comprises at least one of information on whether the task corresponding to the received user input is executed or, if the task is not executed, a cause of non-execution.

16. The electronic device of claim 14, wherein the memory stores instructions that, when executed by the processor, cause the processor to display the notification information on an execution result of the task based on at least one data related to the notification information, the at least one data comprising at least one of content of the notification information according to the execution result or a display format of the notification information on the second user interface.

17. The electronic device of claim 14, wherein the memory stores instructions that, when executed by the processor, cause the processor to display no transmission of data related to the user's utterance to the external server based on non-existence of the task corresponding to the user's utterance.
